(19) United States
(12) Patent Application Publication
(10) Pub. No.: US 2024/0393441 A1
(43) Pub. Date: Nov. 28, 2024

(54) OPTOELECTRONIC SENSOR AND METHOD FOR MEASURING CONTAMINATION OF A FRONT SCREEN

(71) Applicant: SICK AG, Waldkirch (DE)

(72) Inventors: Gregor HUBER, Waldkirch (DE); Alice MAGIN, Waldkirch (DE); Thomas DOLLMANN, Waldkirch (DE); Martin KUFNER, Waldkirch (DE); Scott MARSDEN, Waldkirch (DE)

(21) Appl. No.: 18/674,689

(22) Filed: May 24, 2024

(30) Foreign Application Priority Data
May 25, 2023 (EP) 23175231.2

(51) Int. Cl. G01S 7/497; G01S 7/481; G01S 17/87

(52) U.S. Cl. CPC G01S 7/497; G01S 7/4813; G01S 7/4817; G01S 17/87; G01S 2007/4975

(57) ABSTRACT

An optoelectronic sensor is provided that has a front screen, a measuring unit, a movable deflection unit, and a contamination test unit moved along with the deflection unit for generating a received contamination test signal from contamination test light reflected at the front screen. In this respect, the contamination light unit has at least two contamination test light transmitters and/or at least two contamination test light receivers to form a plurality of contamination test channels and a control and evaluation unit is configured to detect the object by evaluating a received measurement signal of the measuring unit and to evaluate the contamination of the front screen by evaluating the plurality of received contamination test signals of the plurality of contamination test channels.

The invention relates to an optoelectronic sensor, in particular to a laser scanner, for the detection of at least one object in a monitored zone and to a method of measuring contamination of a front screen of an optoelectronic sensor respectively.

In a laser scanner, a light beam generated by a laser periodically sweeps over a monitored zone with the help of a deflection unit. The light is remitted at objects in the monitored zone and is evaluated in the scanner. A conclusion is drawn on the angular location of the object from the angular position of the deflection unit and additionally on the distance of the object from the laser scanner from the time of flight while using the speed of light in a phase method or pulse method. To increase the range with a limited light pulse energy, some conventional laser scanners transmit a plurality of light pulses per distance value and balance the results of these individual measurements to form a common measured value. Such a laser scanner using a pulse averaging method is known, for example, from DE 10 2010 061 382 A1. The location of an object in the monitored zone is detected in two-dimensional polar coordinates using the angular data and the distance data. The positions of objects can thus be determined or their contour can be determined. The scan movement is achieved by a rotating mirror or a polygonal mirror wheel in most laser scanners. In some laser scanners, such as that in accordance with DE 197 57 849 B4, the total measuring head with the light transmitters and light receivers instead rotates. While most known laser scanners work with a single scanning beam and accordingly only detect one central scan plane, there are also endeavors to implement a multiplane scanner by a plurality of scanning beams. This can be combined with a pulse averaging process.

Laser scanners are also used in safety technology for monitoring a danger source, such as a hazardous machine. Such a safety laser scanner is known from DE 43 40 756 A1. In this process, a protected field is monitored which may not be entered by operators during the operation of the machine. If the laser scanner recognizes an unauthorized intrusion into the protected field, for instance a leg of an operator, it triggers an emergency stop of the machine. Sensors used in safety technology have to work particularly reliably and must therefore satisfy high safety demands, for example the EN13849 standard for safety of machinery and the machinery standard EN61496 for electrosensitive protective equipment (ESPE).

A laser scanner is often used in rough environments in which it comes into contact with dust, dirt, water, and similar contaminants. This impairs the transmission capability of a front screen of the laser scanner and increases the scattering there. As a rule, the laser scanner is designed such that this is tolerated up to a certain degree. However, there is then a loss in range or there are incorrect measurements with possibly serious consequences. It is therefore known to monitor the transmission capability of the front screen, which is also called contamination measurement. This enables corresponding warning states or error states of the laser scanner when impairments occur. A front screen monitoring is even unavoidable for use in safety engineering.

A conventional solution that is described in DE 43 45 445 C2, for example, provides a plurality of independent optical test channels of respective transmitter/receiver pairs that are arranged distributed over the entire angular range of the front screen. This principle is furthermore used in a plurality of laser scanners. Since every test channel can only perform one selective measurement of the front screen, a correspondingly high number of components is required for this purpose. In addition, a partner of the transmitter/receiver pair or alternatively, in a reflective arrangement, at least one reflector has to be attached outside the front screen. It would, however, be desirable, for the front screen to terminate the unit, particularly since outwardly disposed components are themselves exposed to contamination.

To avoid the plurality of test channels, a so-called co-rotating contamination measurement is possible. In this respect, a transmitter/receiver pair moves with the deflection unit or the rotating mirror for the scan movement and thus successively tests the transmission capability of the front screen. However, a reflector outside the front screen is in turn used for this purpose. Optical crosstalk on the actual measurement system can moreover be problematic. EP 2 237 065 A1 discloses such a laser scanner in which the complete measuring unit with the light source and the detector rotates. A test light source and a test detector are moreover accommodated on the corresponding rotor while a reflector element is arranged outside the housing. The test light source and the test detector thus scan the front screen in the course of the rotation with the aid of the reflector element. A similar window pane monitoring is also known from EP 2 388 619 A1. A test light transmitter and a test light receiver are arranged in the vicinity of the outer periphery of a rotor of the rotating measuring head in EP 4 086 661 A1 to radiate through the front screen from below, with a reflector completing the test light path at the upper side.

A further conventional approach comprises deriving the contamination measurement from the actual distance measurement. The exiting measurement light causes an internal front screen reflection that is typically considered as an interference effect and is, for example, deflected into an optical trap, but in principle carries information on the optical properties of the front screen within it. There is a difficulty in that only the exit zone, but not a differing entry zone of the front screen is thus tested. In addition, the measurement function can be overloaded and impaired, for instance because some of the measurement time is taken up.

In EP 3 078 985 A1, a reflector rotates relative to stationary pairs of a test light transmitter and a test light receiver. A somewhat wider region of the front screen can thus be tested per test channel, but the plurality of test channels is not thereby avoided. EP 2 508 914 A1 uses a similar concept, with the difference that the reflector is attached to a transmission tube here and not directly to the rotating mirror. US 2008/0158555 A1 shows a further front screen monitoring via a co-rotating reflector.

DE 100 25 511 C1 conducts measurement radiation for the contamination monitoring of a window of a laser scanner to the lower side of the window via its rotating mirror. The measurement radiation is there deflected by a mirror surface extending over the length of the window to the upper side of the window where a series of measurement receivers is arranged. Due to a curved contour of the window, the measurement radiation is guided through the window multiple times on its way from the lower side to the upper side. This is a kind of hybrid of a co-rotating contamination measurement and a plurality of test channels that still requires a large number of components, however. DE 197 06 612 A1 has a somewhat different construction design, but pursues the same principle. EP 3 511 739 A1 expands the idea to the extent that the test light for testing the front screen is guided back in a receiver arranged on the axis of rotation so that a co-rotating contamination measurement is effectively implemented.

It is therefore the object of the invention to further improve the front screen monitoring or the contamination measurement.

This object is satisfied by an optoelectronic sensor, in particular a laser scanner, for the detection of at least one object in a monitored zone and by a method of measuring contamination of a front screen of an optoelectronic sensor in accordance with the respective independent claim. The sensor comprises a measuring unit having at least one measurement light transmitter and at least one measurement light receiver to transmit measurement light into the monitored zone and to receive it again from there to generate a received measurement signal. A front screen is provided in a housing of the sensor to allow the measurement light to pass through. A movable deflection unit periodically deflects the measurement light and thus provides a repeat scan of a partial zone of the monitored zone, for example a scan plane. The movable deflection unit is preferably configured as a movable measuring head having the measuring unit, but alternatively a rotating mirror or the like can also be used.

A contamination test unit is co-moved with the deflection unit to test the front screen for contamination. The contamination test unit has at least one contamination test light transmitter and at least one contamination test light receiver. A received contamination test signal is thus generated from contamination test light reflected at the front screen. A front screen reflection is thus measured, the evaluated portion of the contamination test light does not penetrate the front screen or only penetrates it up to contamination on the outer side. The measuring unit and the contamination test unit are initially only umbrella terms for the corresponding functional units, but they can also be configured as construction modules. The corresponding prefixes should only make it possible to distinguish the association for the respective light transmitters and light receivers, for example.

In a control and evaluation unit, the received measurement signal is evaluated, on the one hand, to detect the object, that is, for example, to determine whether there is an object in the respective irradiation direction and preferably to measure its distance using a time of light process. On the other hand, the received contamination test signal is evaluated to evaluate the contamination of the front screen and thus to at least indirectly evaluate its transmissibility.

The invention starts from the basic idea of using a multichannel contamination measurement. Multichannel means that a plurality of received contamination test signals are acquired and evaluated in the respective position of the deflection unit. The contamination test unit has at least two contamination test light transmitters and/or at least two contamination test light receivers for this purpose. A contamination test channel respectively comprises a contamination test light transmitter and a contamination test light receiver and different combinations and thus light paths and points of incidence of the contamination test light on the front screen are produced by the selection of such pairs. A contamination test light transmitter or a contamination test light receiver can be used multiple times in different contamination test channels. The contamination test channels preferably work in a time offset manner. The sequence can be changed very quickly due to the extremely short light paths. The plurality of received contamination test signals are then evaluated together to achieve an evaluation of the contamination of the front screen overall.

The invention has the advantage that a gapfree monitoring of the front screen is made possible in all positions of the movable deflection unit. In this respect, the penetration region of both the exiting and entering measurement light is fully testable. The sections or segments of the front screen to be tested can be configured practically as desired in the direction of movement of the deflection division. Only a few components are required so that the hardware and cost effort remains small. The front screen can represent the outermost unit edge; outwardly disposed components are not required for the contamination measurement. The light paths of the measurement light and the contamination test light can be decoupled so that the contamination measurement does not influence the actual measurement. The evaluation in accordance with the invention moreover makes a distinction possible between near objects of the monitored zone and a contamination of the front screen so that false triggerings of the contamination test can be intercepted.

If the sensor has a measuring unit moved along with the deflection unit, a data and energy transmission into the movable part of the sensor that can also be used by the contamination measurement is anyway already required. The additional construction space requirement and hardware effort for the contamination measurement is then particularly small. The sensor can be configured as multibeam, in particular as a multilayer scanner, to detect a larger portion of the monitored zone. For this purpose, a plurality of scanning beams are produced at the transmission side and/or at the reception side by a plurality of measurement light transmitters and/or beam decouplers or by a plurality of measurement light receivers.

A direction of radiation of the contamination test light is preferably transverse, in particular perpendicular, to a direction of radiation of the measurement light. Optical crosstalk is greatly reduced or is fully prevented by different orientations of the actual measurement and the contamination measurement. The contamination measurement does not have any disruptive effect on the actual measurement even without a time decoupling.

The control and evaluation unit is preferably configured to compare a respective received contamination test signal with a reference value for the evaluation of the transmissibility of the front screen. This comparison preferably takes place per received contamination test signal or contamination test channel. The reference value forms the evaluation basis for a new or clean front screen, for example.

The control and evaluation unit is preferably configured for a teaching mode in which received contamination test signals are stored as reference values. This is again preferably done per received contamination test signal or contamination test channel. The sensor is thus calibrated to a desired state, whether ex works or, for example, with a new front screen or a front screen that is clean after a manual test. The teaching mode can be invoked for a recalibration, for example by pressing a button or by selecting a corresponding function in configuration software, for instance after the front screen has been changed or cleaned.

The control and evaluation unit is preferably configured to measure a received contamination test signal with an inactive contamination test light transmitter to compensate it as a background signal of a received contamination test signal detected with an active contamination test light transmitter. A background masking is thus implemented that reduces or eliminates the influence of the environmental light on the contamination measurement. The background masking preferably takes place per contamination test channel, with it sufficing to measure contamination test signals with an inactive contamination test light transmitter only once per contamination test light receiver. Background masking preferably takes place for the received contamination test signals of a contamination measurement in operation and/or for the detection of reference values. To do justice to the dynamic behavior of the sensor with its moving deflection unit, the two measurements preferably take place with an inactive and an active contamination test light transmitter very shortly after one another and thus in a direct temporal and spatial relationship. Very shortly after one another means that the deflection unit is still at practically the same angular position, with no mathematical precision being required here, but an angular segment to be evaluated the same rather being sufficient.

The sensor preferably has a temperature sensor, with the control and evaluation unit being configured to adapt a received contamination test signal or a reference value using a temperature measured by the temperature sensor. A temperature compensation of the contamination measurement thus takes place. It is possible to adapt the received contamination test signals and/or the reference value to the measured temperature. The temperature adaptation can take place using a calculation rule, in particular a simple linear temperature factor, or, for example by means of a lookup table (LUT).

The sensor preferably has a temperature reference channel having a temperature reference light transmitter, a temperature reference light receiver, and an internal temperature reference target arranged within the housing to adapt a received contamination test signal or a reference value using a temperature reference signal of the temperature reference light receiver. The temperature behavior is thereby transferred from the temperature reference channel to the contamination measurement. A temperature measurement is then no longer required, but is redundantly possible.

The contamination test unit preferably has at least two contamination test light transmitters and at least two contamination light receivers in an alternating linear arrangement. The minimal configuration of a contamination test light transmitter and two contamination test light receivers is thus expanded to provide additional contamination test channels. The alternating arrangement can be understood in a strictly alternating sense . . . ESESE . . . (S for contamination test light transmitter, E for contamination test light receiver), but also in a more irregular sense such as EESEESEE, ESEESSEESE. A nonlinear, that is two-dimensional, arrangement is alternatively conceivable.

The arrangement is preferably arranged obliquely to or in parallel with an axis of rotation of the movable deflection unit. The arrangement of the contamination test light transmitters and the contamination test light receivers is illustratively thus perpendicular in the unit to test sections of the front screen disposed above one another. A certain slant is permitted here if it has construction advantages, for example.

The contamination test channels preferably have at least one direct channel that is formed by a contamination test light transmitter and a contamination test light receiver not directly adjacent. A direct channel is thus spanned by a pair of contamination test light transmitter and contamination test light receiver disposed next to one another. This enables a direct test of the associated site of incidence on the front screen having the shortest light paths and the steepest angles.

The contamination test channels preferably have at least one indirect channel that is formed by a contamination test light transmitter and a directly adjacent contamination test light receiver. An indirect channel is therefore a counterpiece to a direct channel having somewhat longer light paths and shallower angles. A combination of at least one direct channel with at least one indirect channel is particularly advantageous. Indirect channels are particularly suitable for a distinction of contamination and a near object of the monitored zone since namely the latter generates a substantially greater received contamination test signal in an indirect channel.

The control and evaluation unit is preferably configured to evaluate the transmissibility of the front screen in a plurality of angular segments corresponding to positions of the movable deflection unit and in particular not to evaluate the transmissibility for at least one configurable angular segment. The contamination measurement is thus related to sections of the front screen. The enables a differentiated diagnosis and, for example, an indication to the use of where the front screen is to be cleaned. Angular segments can furthermore be treated differently; for example, contaminated angular segments can be tolerated if no measurement is required here or if the corresponding section is anyway obstructed and is blocked for the measurement.

The control and evaluation unit is preferably configured to compare measured results of the measuring unit and of the contamination test unit with one another, in particular not to evaluate the transmissibility of the front screen and/or to treat a fast increase in the contamination as a detected object on a detection of an object by the measuring unit in this position of the deflection unit Such cross-comparisons between the actual measurement and the contamination measurement can result in more robust results and can avoid false alarms of the contamination measurement. Conversely, the contamination measurement can possibly support the actual measurement in the extreme near zone. For contamination is a slow procedure so that a fast change within one or a few periods of the movement of the deflection unit can be the result of an object. It may occur that a raindrop or a splash of mud on the front screen is then, for example, treated as a near object instead of as contamination, which, however, produces the correct result of assuming a near object as a precaution.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

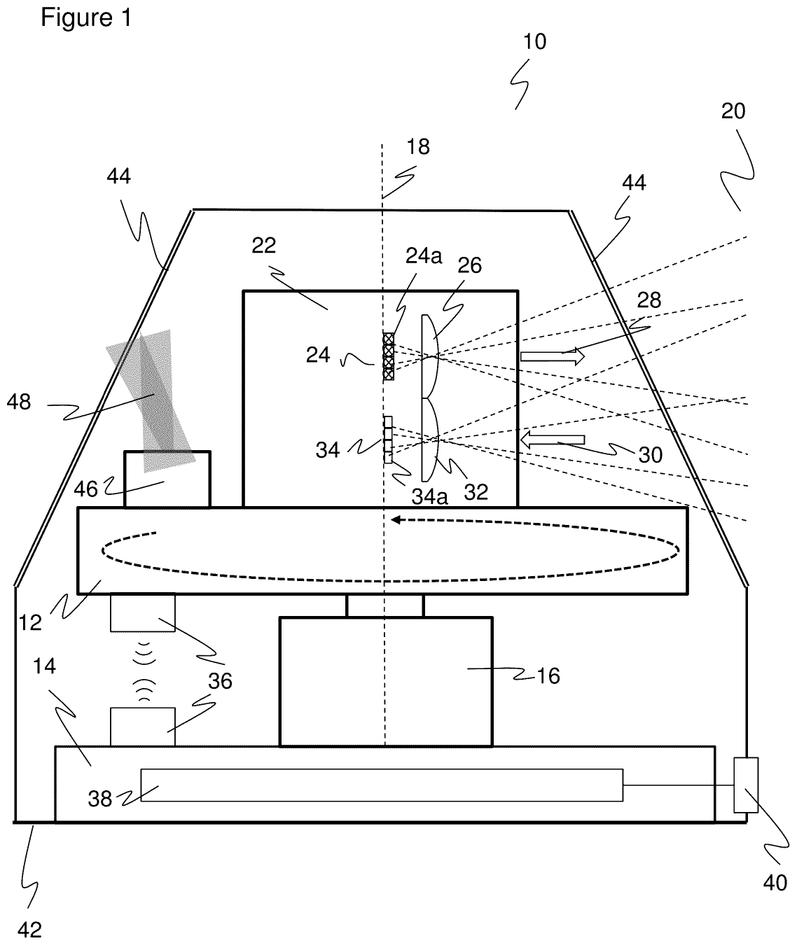

FIG. 1 a schematic sectional representation of a laser scanner with a co-rotating contamination measurement;

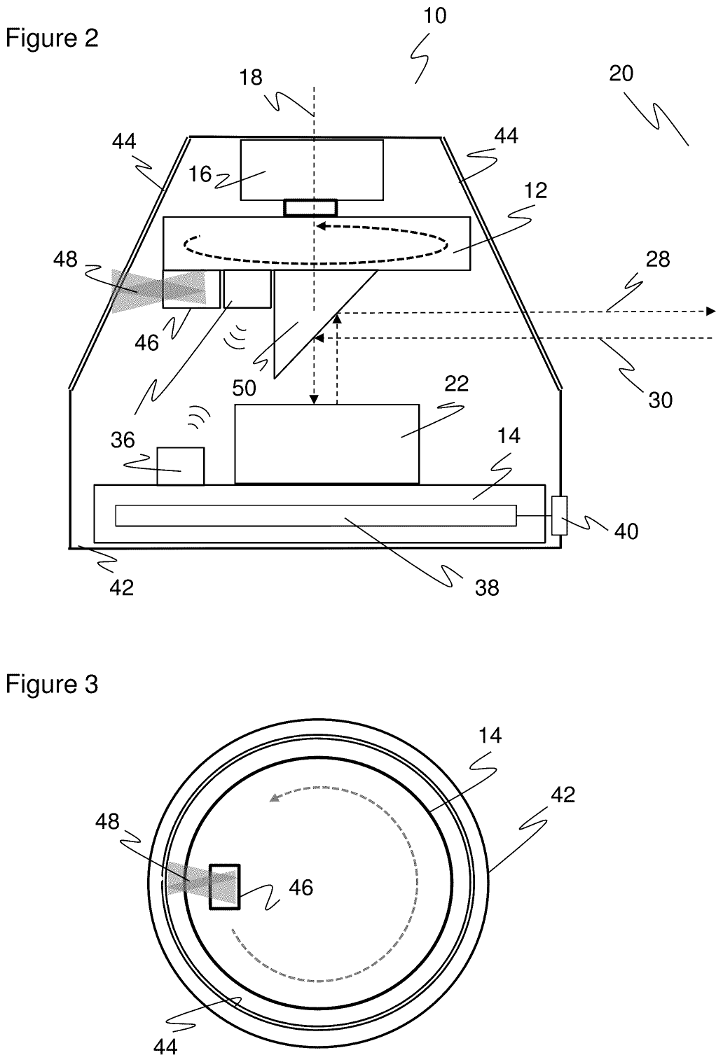

FIG. 2 a simplified schematic sectional representation of a further laser scanner having a rotating mirror instead of a rotating measuring head;

FIG. 3 an again simplified schematic sectional representation of a laser scanner with a co-rotating contamination measurement from above;

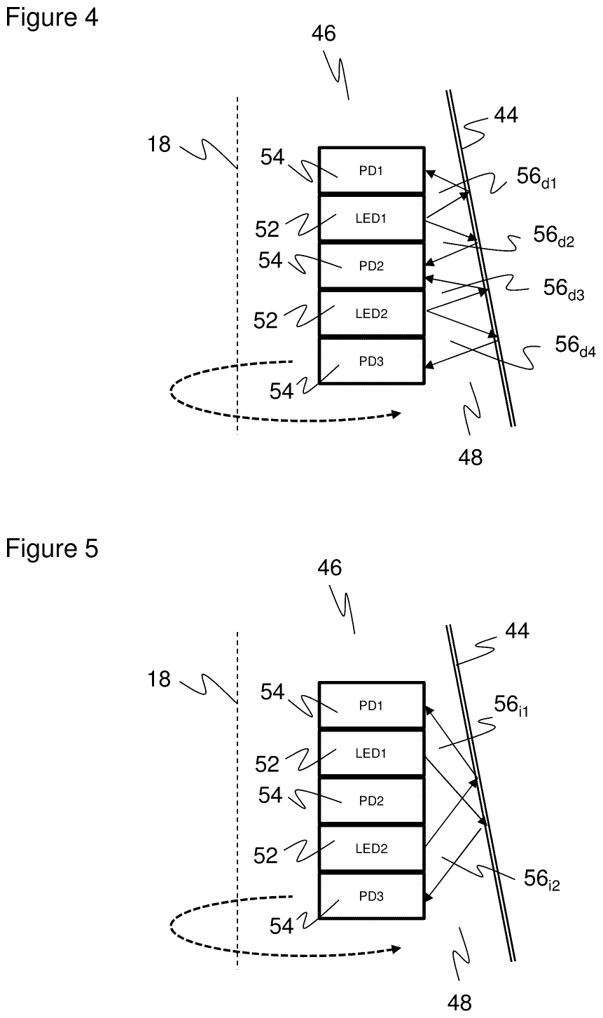

FIG. 4 a representation of a contamination test unit with its direct channels;

FIG. 5 a representation of the contamination test unit in accordance with FIG. 4, now with its indirect channels;

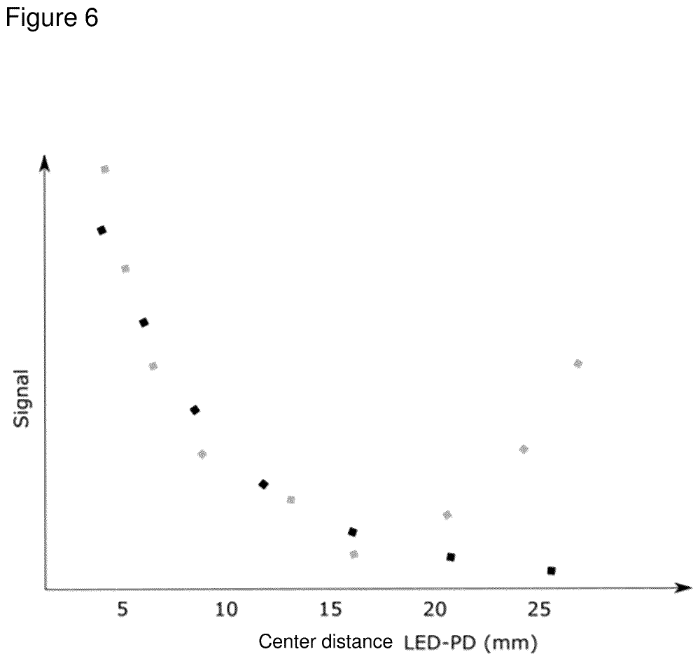

FIG. 6 a comparative representation of the signals of a contamination test unit with a contamination and with a near object of the monitored zone in dependence on the distance between the contamination test light transmitter and the contamination test light receiver; and

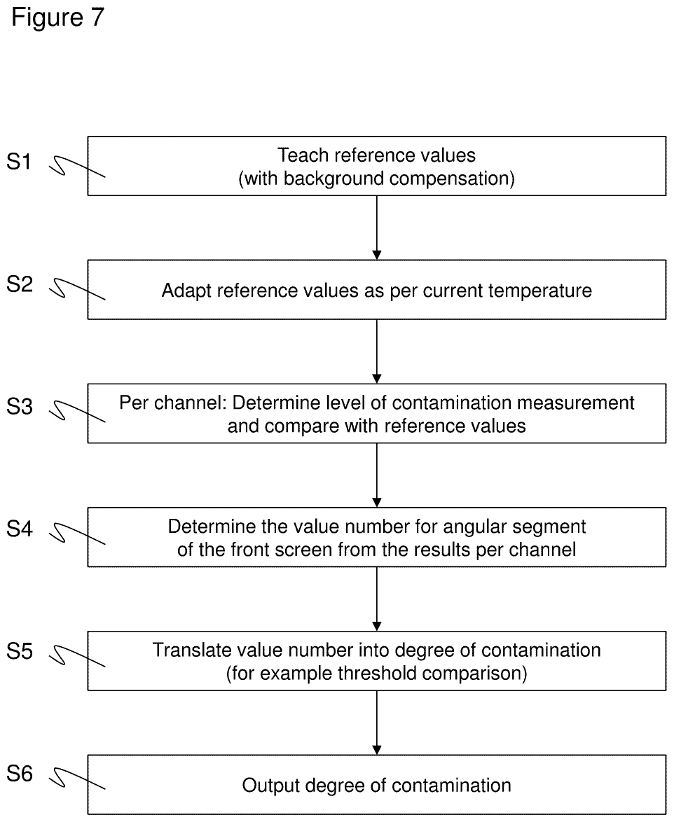

FIG. 7 an exemplary flowchart of a contamination measurement.

FIG. 1 shows a schematic sectional representation through an optoelectronic sensor 10 in an embodiment as a laser scanner. The sensor 10 in a rough distribution comprises a movable deflection unit 12 and a base unit 14 that can also be understood as a rotor and a stator. The deflection unit 12 carries the optical measuring head, whereas further elements such as a supply, evaluation electronics, terminals and the like are accommodated in the base unit 14. In operation, the deflection unit 12 is set into a movement about an axis of rotation 18 with the aid of a drive 16 of the base unit 14 to thus periodically scan a monitored zone 20.

A measuring unit 22 is also moved together with the deflection unit 13, in which measuring unit 22 a light transmitter 24 having a plurality of light sources 24a, for example LEDs or lasers in the form of edge emitters or VCSELs, produces a plurality of transmitted light beams 28 with the aid of a common transmission optics 26 that are transmitted into the monitored zone 20. In the example shown, there are four transmitted light beams 28 for four scan planes; there can be more, also considerably more, and, equally, fewer scanning beams 28. Individual optics are possible instead of a common transmission optics 26. The plurality of scanning beams 28 can also be produced in that the light of a light source or of some light sources is split by a beam splitter element, a diffractive optical element, or the like.

If the transmitted light beams 28 impact an object in the monitored zone 20, corresponding remitted light beams 30 return to the sensor 10. The remitted light beams 30 are conducted by a common reception optics 32 to a light receiver 34 having a plurality of light reception elements 34a that each generate an electric reception signal. The light reception elements 34a can be separate elements or pixels of an integrated matrix arrangement, for example photodiodes, APDs (avalanche diodes), or SPADs (single photon avalanche diodes). The remarks on the transmission side also apply accordingly here. A plurality of individual optics can in particular be provided and a plurality of remitted light beams 30 can be detected on a common light reception element,

A larger detection zone is produced in elevation, in particular a multilayer scanner, by a scanning with a plurality of light beams 30. Alternatively, only one light source 24a or only one light reception element 34a can be provided to implement a single beam sensor, in particular a laser scanner having only one scan plane. The basic optical design with light transmitters 24 and light receivers 34 biaxially disposed next to one another is also not compulsory and can be replaced with any construction design known per se of single-beam optoelectronic sensors or laser scanners. An example for this is a coaxial arrangement with or without beam splitters.

A contactless supply and data interface 36 connects the moving deflection unit 12 to the stationary base unit 14. A control and evaluation unit 38 having at least one processing unit is located there. Examples for this are digital processing modules such as a microprocessor or a CPU (central processing unit), an FPGA (field programmable gate array), a DSP (digital signal processor), an ASIC (application specific integrated circuit), an AI processor, an NPU (neural processing unit), a GPU (graphics processing unit) or the like. Thanks to the contactless data interface 36, the control and evaluation unit 38 can also be provided, differing from the illustration, partly or fully in the movable deflection unit 12.

The control and evaluation unit 38 controls the light transmitter 24 and receives the received signals of the light receiver 34 for a further evaluation. It additionally controls the drive 16 and receives the signal of an angular measuring unit which is not shown, which is generally known from laser scanners and which determines the respective angular position of the deflection unit 12. The distance from a scanned object is measured for the evaluation. Together with the information on the angular position of the angular measuring unit, two-dimensional polar coordinates of all object points in a scan plane are available after every scanning period with angle and distance. The respective scan plane is likewise known via the identity of the respective light beam 28, 30, provided that there are a plurality of scan planes, so that a three-dimensional spatial zone is scanned overall.

The object positions or object contours are thus known and can be output via a sensor interface 40. The sensor interface 40 or a further terminal, not shown, conversely serves as a parameterization interface. The sensor 10 can be configured as a safety laser scanner, with the control and evaluation unit 38 then in particular being configured to compare the position of detected objects with protected fields and to control a safe output by a shutdown signal on recognition of an unauthorized protected field intrusion.

All the named functional components are arranged in a housing 42 which has a peripheral front screen 44 in the region of the light exit and of the light entry. The front screen 44 is frequently, but not necessarily, formed as a rotational member and also does not necessarily have to extend over 360° in both cases so that then a certain angular range remains as a dead zone. The front screen 44 shown is frustoconical and is therefore slanted with respect to the optical axis of the measuring unit 22. Alternative shapes of the front screen 44 having, for example, the form of a spherical or cup-shaped contour or curvature are likewise conceivable.

A contamination test unit 46 that makes it possible to recognize contaminations of the front screen 44 and that will be explained in more detail below with reference to FIGS. 4 to 7 is provided in the sensor 10 and is moved along with the deflection unit 12. The contamination measurement is based on a backscattering of contamination test light 48 from the front screen 44 and enables a wide-area vertical scan of the front screen 44 and a gapless monitoring of the contamination in the direction of movement of the deflection unit 12. The contamination test unit 46 can be arranged and aligned as shown such that it does not influence the measuring unit 22 either optically, mechanically, electrically, or on a digital plane. The contamination test unit 46 is connected via the contactless supply and data interface 36 so that the control and evaluation unit 38 is also responsible for its control and evaluation.

FIG. 2 shows a simplified schematic sectional representation of a further embodiment of the sensor 10. The measuring unit 22 is here located in the base unit 14 and therefore does not also execute the movement of the deflection unit 12, The periodic scanning is instead implemented with the aid of a rotating mirror 50 that rotates with the deflection unit 12. The contamination test unit 46 is furthermore moved along with the deflection unit 12 and is therefore connected to the contactless supply and data interface 36. The beam direction of the contamination test light 48 is here different from that in in FIG. 1, which should only illustrate that variations in this respect are possible in all the embodiments of the sensor 10. What is important is that the contamination test light 48 actually tests a zone of the front screen 44 that the light beams 38, 30 of the measuring unit 22 also use, with an angle offset, and a time offset resulting therefrom, being permitted in the direction of movement of the deflection unit 12.

FIG. 3 shows an again simplified schematic representation of the sensor 10 from above to further illustrate the basic arrangement. FIG. 3 can be understood as a plan view of both the sensor 10 in accordance with FIG. 1 and of the sensor 10 in accordance with FIG. 2. In the course of the movement of the deflection unit 12, the contamination test unit 46 or its contamination test light 48 reaches every angular position, whereby a gapfree monitoring of the front screen 44 becomes possible. The front screen 44 can be divided into any desired number of angular ranges or segments for the evaluation of the contamination measurement. Only the required measuring and processing times, that do not permit any desired fine-grain division, set limits here. A division into segments allows, for example, selected segments to be excluded from the monitoring if, for example, the sensor 10 is anyway obstructed such that only a portion of the front screen 44 is still accessible. Since contamination is a slow process as a rule, a measurement can be extended over a plurality of periods of the movement of the deflection unit 12 or can be accumulated, for example averaged. This makes it possible to further increase the number of segments.

FIG. 4 shows a representation of the contamination test unit 46. It has light transmitters 52 and light receivers 54 that are at times called contamination light transmitters and contamination light receivers to distinguish them from the light transmitter 24 and the light receiver 34 of the measuring unit 22 that may be called measurement light transmitters and measurement light receivers for the same reason. The light transmitters 52 and light receivers 54 can form different pairs and can generate a respective received contamination test light signal with the contamination test light 48 respectively transmitted and received again after reflection at the front screen 44. The respective pairs are called channels. Respective pairs of directly adjacent light transmitters 52 and light receivers 54 are formed in FIG. 4. This is called a direct channel.

To be able to form a plurality of channels, at least more than one light transmitter 52 or more than one light receiver 54 must be provided, preferably both. An embodiment is shown by way of example having two light transmitters 52 (S) and three light receivers 54 (E) in an alternating sequence ESESE. The shown four direct channels 56_{d1}-56_{d4} can thus be formed. Different numbers and different sequences are conceivable, for example ESEESE or ES(blank)E and many more. Instead of an arrangement vertically above one another, a slanted arrangement would also be conceivable if it promises advantages, for example, with respect to the construction space utilization or the heat dissipation or for a specific front screen geometry, as a curved free-form surface, for instance. However, care should preferably be taken that the distance between the light transmitters 52 or light receivers 54 and the front screen 44 remains as small as possible and remains constant during the movement of the deflection unit 12.

The light transmitters 52 preferably have a wide irradiation angle and a non-transparent base or a lateral shield such as a ring impermeable to light to prevent lateral scattered light, in particular directly into the light receivers 54, since this would generate an interfering signal portion. A large reception angle is of advantage for the light receivers 54 to be able to detect as much scattered back contamination test light 48 as possible.

FIG. 5 shows a representation similar to FIG. 4, but now with indirect channels 56ᵢ₁-56ᵢ₂ that combine respectively not directly adjacent light transmitters 52 and light receivers 54 with one another. The component distance between the light transmitter 52 and the light receiver 54 in an indirect channel is therefore larger than in a direct channel and also varies between the indirect channels in dependence on the arrangement. Additional information can thereby be acquired that allows an improved evaluation of the contamination state of the front screen 44. The indirect channels in particular make a distinction possible between a contamination and a near object in the monitored zone 20.

FIG. 6 shows a comparative representation of the signals of a contamination test unit with a contamination and with a near object of the monitored zone 20 in dependence on the distance between the light transmitter 52 and the light receiver 54 of a channel. The dark spots are measured for the signal from the near object, the light spots for the signal from a contaminated front screen 44. No obvious difference results for small distances between the light transmitter 52 and the light receiver 54. However, the values diverge substantially for larger distances, above approximately 20 mm in FIG. 6 by way of example. A near object here delivers a considerably higher signal than a contamination and a distinction can thus be made between these two cases.

Direct channels have a smaller distance between the light transmitter 52 and the light receiver 54, indirect channels have a smaller distance corresponding to the right part of FIG. 6. A strong signal thus results in the direct channels on a contamination of the front screen 44, whereas the indirect channels only show a very weak signal due to the shallow angle of incidence onto the front screen 44. All the channels show strong signals with a near object in contrast. The indirect channels thus make the difference in the right part of FIG. 6 accessible and permit a distinction between a near object and a contamination.

FIG. 7 shows an exemplary flowchart of a contamination measurement. Reference values are taught in a step S1. They are signal levels of the channels used later in operation in a specified state of the front screen 44, for example ex works or when the front screen 44 has been cleaned or replaced. The reference values can accordingly be considered desired values for a sufficiently clean front screen 44.

Background masking preferably takes place in the determination of reference values and equally, as later in operation, in the measurement of received contamination test signals. For this purpose, for example, measurement takes place in the respective channel once with an active light transmitter 52 and once with an inactive light transmitter 52 and the difference is formed. The digital suppression of the background by a background measurement with an inactive light transmitter 52 can be complemented by an electric high pass filter.

A temperature compensation takes place in a step S2. The temperature dependence of the behavior of the light transmitters 52 and light receivers 64 is thus at least partly compensated. In accordance with the routine of FIG. 7, the reference values are adapted to a currently measured temperature. The measured received contamination test signals could be adapted instead. The temperature adaptation can be simple; for example an empirical temperature constant can be multiplied by the temperature difference between the current temperature and a reference temperature and this temperature portion can be added to the reference values. Alternatively, more complication calculation rules or a lookup table are conceivable.

A received contamination test signal is measured for every channel to be included in a step S3. The already addressed background compensation by a further measurement with an inactive light transmitter 52 also preferably takes place here. Optionally, channels are excluded from the further evaluation in which the background light alone generates a high signal level because it cannot then be expected that a relevant received contamination test signal can be generated even in the case of contamination. The respective, preferably background compensated received contamination test signal is compared with the associated reference value of the channel, for example a quotient is formed.

The measurements in the channels preferably take place with a time offset to avoid crosstalk or because the light transmitter 52 and the light receiver 54 are involved in a plurality of channels. A single measurement in which the light transmitter 52 of a channel is pulsed and the associated light receiver 54 is read is, however, very short so that no excessive demands have to be made on the time sequence. The time sequence of the channels is in particular arbitrary. All the channels should only be measured in the same angular segment, whereby the smallest grain of the angular segments has a certain lower limit.

In a step S4, the results of the individual channels are combined to acquire a common value number for the respective angular segment. The highest signal level among the direct channels is used as the value number, for example to tend to overestimate the contamination as a precaution or another offset such as a mean value, a quantile, or the like. Some exceptions are optionally intercepted. If, for example, the signal level in the indirect channels is too high, a near object is assumed and no contamination measurement is therefore possible for this angular segment at this moment. Too many channels can also be invalid overall due to too much background light; for example, fewer than two direct channels have contributed a sensible received contamination test signal at all. No contamination measurement is also then not possible for this angular segment at this moment.

The value number is translated into a degree of contamination in a step S5. For example, a threshold for a binary decision between still sufficiently transmissible and contaminated can be specified for this purpose or a plurality of thresholds for a more differentiated degree of contamination such as no relevant contamination, still functional, but impending failure, and measurement capability no longer ensured.

The degree of contamination at the sensor 10 or at a connected unit is output or displayed in a step S6. It can be indications corresponding to the previous paragraph, a descriptive output such as “front screen lightly/moderately/heavily contaminated” or a warning. Which degrees of contamination are relevant and the form in which they are to be responded to can differ from application to application and a configuration is therefore also conceivable that can include the step S5.

It is conceivable in an advantageous further development of the invention to include measurements of the measuring unit 22 in the contamination measurement or vice versa. For example, a contamination measurement for an angular segment can be skipped if the measuring unit 22 has detected an object there or has detected one briefly beforehand. Conversely, a fast change of the degree of contamination can be an indication for the actual measurement by the measuring unit 22 that a near object would have to be present since contamination collects slowly as a rule and does not suddenly occur. Cases of rapid contamination such as by a splash of mud or a raindrop cannot be unambiguously assigned here, but can also actually not be unambiguously classified either as a near object or as contamination. A time factor could be included here. A persistently occurring near object ultimately has the same impairing effect on the further measurements as contamination. In any case, the sensor 10 has all the required knowledge that a measurement at greater distances is not currently possible in the affected angular segment so that it can be appropriately responded to.

It may be sensible in some applications to recalibrate the contamination measurement, that is in particular to teach the reference values again in accordance with step S1. Examples include the cleaning of the front screen or a replacement of the front screen 44 by a replacement part. The recalibration can be triggered by an actuation element of the sensor 10 or by configuration software and care should be taken during the teaching that no objects are in the vicinity of the sensor 10.

1. An optoelectronic sensor for the detection of at least one object in a monitored zone,
comprising a housing having a front screen;
a measuring unit having at least one measurement light transmitter for transmitting measurement light through the front screen and at least one measurement light receiver for generating a received measurement signal from measurement light remitted by the object;
a movable deflection unit for the periodic deflection of the measurement light;
a contamination test unit moved along with the deflection unit and having at least one contamination test light transmitter for transmitting contamination test light onto the front screen and at least one contamination test light receiver for generating a received contamination test signal from contamination test light remitted at the front screen;
and a control and evaluation unit that is configured to detect the object by evaluating the received measurement signal and to evaluate the contamination of the front screen by evaluating the received contamination test signal,
wherein the contamination test unit has at least two contamination test light transmitters and/or at least two contamination test light receivers to form a plurality of contamination test channels; and wherein the control and evaluation unit is configured to evaluate the contamination of the front screen using the received contamination test signals of the plurality of contamination test channels.

2. The optoelectronic sensor in accordance with claim 1, wherein the optoelectronic sensor is a laser scanner.

3. The optoelectronic sensor in accordance with claim 1,
wherein a direction of radiation of the contamination test light is transverse to a direction of radiation of the measurement light.

4. The optoelectronic sensor in accordance with claim 1,
wherein a direction of radiation of the contamination test light is perpendicular to a direction of radiation of the measurement light.

5. The optoelectronic sensor in accordance with claim 1,
wherein the control and evaluation is configured to compare a respective received contamination test signal with a reference value for the evaluation of the contamination of the front screen.

6. The optoelectronic sensor in accordance with claim 5,
wherein the control and evaluation unit is configured for a teaching mode in which received contamination test signals are stored as reference values.

7. The optoelectronic sensor in accordance with claim 1,
wherein the control and evaluation unit is configured to measure a received contamination test signal with an inactive contamination test light transmitter to compensate it as a background signal of a received contamination test signal detected with an active contamination test light transmitter.

8. The optoelectronic sensor in accordance with claim 1,
that has a temperature sensor, and wherein the control and evaluation is configured to adapt a received contamination test signal or a reference value using a temperature measured by the temperature sensor.

9. The optoelectronic sensor in accordance with claim 1
that has a temperature reference channel having a temperature reference light transmitter, a temperature reference light receiver, and an internal temperature reference target arranged within the housing to adapt a received contamination test signal or a reference value using a temperature reference signal of the temperature reference light receiver.

10. The optoelectronic sensor in accordance with claim 1,
wherein the contamination test unit has at least two contamination test light transmitters and at least two contamination light receivers in an alternating linear arrangement.

11. The optoelectronic sensor in accordance with claim 10,
wherein the arrangement is slanted to or in parallel with an axis of rotation of the movable deflection unit.

12. The optoelectronic sensor in accordance with claim 1
wherein the contamination test channels have at least one direct channel that is formed by a contamination test light transmitter and a directly adjacent contamination test light receiver.

13. The optoelectronic sensor in accordance with claim 1
wherein the contamination test channels have at least one indirect channel that is formed by a contamination test light transmitter and a contamination test light receiver not directly adjacent.

14. The optoelectronic sensor in accordance with claim 1
wherein the control and evaluation unit is configured to evaluate the contamination of the front screen in a plurality of angular segments corresponding to positions of the movable deflection unit.

15. The optoelectronic sensor in accordance with claim 14
wherein the control and evaluation unit is further configured not to evaluate the contamination for at least one configurable angular segment.

16. The optoelectronic sensor in accordance with claim 1
wherein the control and evaluation unit is configured to compare measured results of the measuring unit and of the contamination test unit with one another.

17. The optoelectronic sensor in accordance with claim 16
wherein the control and evaluation unit is further configured not to evaluate the contamination of the front screen.

18. The optoelectronic sensor in accordance with claim 1
wherein the control and evaluation unit is configured to treat a fast increase in the contamination of the front screen as a detected object on a detection of an object by the measuring unit in this position of the deflection unit.

19. A method of measuring the contamination of a front screen of an optoelectronic sensor
that transmits measurement light through the front screen by at least one measurement light transmitter and that generates a received measurement signal from measurement light remitted by the object by at least one measurement light receiver;
that periodically deflects the measurement light by a movable deflection unit;
that transmits contamination test light onto the front screen by at least one contamination test light transmitter moved along with the deflection unit and that generates a received contamination test light signal from contamination test light reflected at the front screen by at least one contamination test light receiver;
the object is detected by evaluating the received measurement signal;
and the contamination of the front screen is evaluated by evaluating the received contamination test signal,
wherein
a plurality of contamination test channels and formed by means of at least two contamination test light transmitters and/or by means of at least two contamination test light receivers; and wherein the contamination of the front screen is evaluated using the received contamination test signals of the plurality of contamination test channels.
